(19) United States
(12) Patent Application Publication
(10) Pub. No.: US 2002/0123916 A1
(43) Pub. Date: Sep. 5, 2002

(54) Method and system for program management

(76) Inventors: Maurice A. Godin, Nepean (CA); David J. Vicary, Nepean (CA)

Correspondence Address: G. RONALD BELL & ASSOCIATES, P O BOX 2450, POSTAL STATION D, OTTAWA, ON, K1P 5W6, CA

(21) Appl. No.: 09/797,973

(22) Filed: Mar. 5, 2001

(51) Int. Cl. G06F 17/60

(52) U.S. Cl. 705/7

(57) ABSTRACT

The present invention provides a system and method that permit the efficient, integrated management of inter-related tasks comprised in a program with respect to their boundaries. The present invention also provides a system and method that permit the efficient management of multiple inter-related programs or activities that span various layers and functions. Since a boundary in one program may be related to other programs or boundaries outside of the first program, the present invention provides a manager with a visual representation of these inter-relationships and permits the manager to determine how the status of a related program or boundary might affect the manager's program. Alternatively, an employee who is currently within all assigned boundaries could access the program manager system and offer help to someone who is having trouble staying within other boundaries.

### FIELD OF INVENTION

The present invention relates to methods and systems for managing a program or project, as well as to the provisioning of information relating to the program or project to participants or other interested parties.

### BACKGROUND OF THE INVENTION

For managers, the ability to efficiently manage their employees and the various tasks that need to be accomplished has always been a primary responsibility. Some managers only have responsibility for one project or program at a time. In such cases, there are many manners in which a manager may seek to keep a project under control. Some of these existing manners are performed manually and some are performed in an automated fashion, with the use of a computer and software. In the case where there is only one project to be considered, the necessary tools, whether manual tools or automated tools, need not normally be extremely sophisticated. In fact, a manager could very well use a generic spreadsheet package or other off-the-shelf software tool and create a project schedule and other such metrics in order to keep the project under control. Typically, a project manager will work with the constraints of time, cost, and performance, among other factors.

Some specialized software tools exist for such project management. One known tool is the Microsoft Project™ software package. This tool provides a powerful environment for managing events within a project, with the ability to roll up events, indicate predecessors of events, calculate critical paths, and reschedule events in order to optimize the project schedule. There is also a very limited provision of resource management in that people may be assigned to events. The software is used mostly to initiate, plan, execute, control and report progress of projects where the emphasis is placed upon using the software to effectively create and manage project schedules using certain accepted project management principles.

However, there are drawbacks to such software tools. One major drawback is the “heavy weight” nature of tools such as Microsoft Project™. That is, these tools are mainly used by professional program/project managers for big projects. These types of project tools also require a major investment in training, as well as in the time required to capture and maintain information. Furthermore, these tools require a great deal of time and effort in order to keep track of the status of related events or outcomes from a plurality of projects. The tools, therefore, end up being limited somewhat by the underlying management theories upon which they are built.

Some management theories exist which are better suited to the management of multiple inter-related projects. One such management theory is known as boundary management, or boundary theory. A boundary is an established limit beyond which the project will be regarded as not meeting its defined goals. In boundary theory, it is held that, by identifying a task by its boundaries, one has a better definition of what must be done, who is accountable for it, and what relationships or expectations are involved. Typically, the team members define the boundaries. This empowers the project team, enables each team member to have a clear indication of the status of all project elements at any given time, and permits any out-of-bounds situations to be flagged. A status indication is usually employed with respect to each project parameter. This status indication will indicate: whether the parameter is within the boundary; whether the parameter is outside the boundary, but can be managed such that the boundary can be met; or whether the parameter has deviated from the boundary without any chance of recovery. The latter indication can only be changed if the boundary itself is modified, or if the situation is significantly altered or realigned such that the parameter may meet the boundary. The boundaries of the project may comprise any limit such as time, cost, performance, etc.

U.S. Pat. No. 5,930,762 issued to Masch on Jul. 27, 1999, describes a computer method for managing risk in multiple-parameter physical systems performing interrelated activities, where at least one of such activities may have an outcome level which may fall outside of boundary limits. The method taught in Masch, however, is concerned with establishing a strategy and picking a course of action with respect to a particular activity which risks falling outside its boundary. The method focuses on the detailed analysis of a subset of conditions in a program, but does not enable a user to consider the totality of the boundaries within a program.

Consequently, if a manager wishes to apply boundary management to a project, the method in Masch can only be used to make specific determinations on a given activity and its boundary, and does not allow management of the entire project and all its boundaries simultaneously.

Furthermore, if this same manager has the responsibility of managing many inter-related projects, the management of such projects is unrealistic without some sort of automated, computerized implementation. Unfortunately, such prior art tools do not permit the use of boundary management in an efficient manner. Moreover, these prior art tools are very much restricted to the particularities of managing specific types of “projects” associated with business planning, engineering or development. As such, they are not sufficiently flexible and do not lend themselves to be used for the management of a wide range of types of program or activity.

### SUMMARY OF INVENTION

Accordingly, it is an object of the invention to provide a system and method that permits the efficient, integrated management of inter-related tasks comprised in a program with respect to their boundaries.

It is another object of the invention to provide a system and method for program management that is applicable to a broader range of programs/projects, i.e. programs of both heavy and light weight; formal and informal programs; and large and small programs.

The term “program” as used hereinafter is intended to cover any activity for which boundaries can be defined.

It is another object of the invention to provide a system and method that permit the efficient management of multiple inter-related programs or activities that span various layers and functions. The present invention permits a visual representation of boundary definitions related to different programs and permits viewing of their inter-relationships in many possible hierarchical views.

According to one aspect of the invention, there is provided a method of managing a program having a defined boundary and an associated tolerance for each of a plurality of program criteria, the method comprising the steps of: providing access to the program criteria and their associated boundaries and tolerances to a user; inputting, by said user, the current status of a particular program criterion with respect to its boundary and the tolerance associated therewith; compiling, at a central computer, a current status for each of said plurality of program criteria; and displaying, on a display means associated with the central computer, the current status for one or more program criteria associated with said program, as well as the status of the boundary of the or each program criterion while having regard to the tolerance associated therewith.

According to another aspect of the invention, there is provided a method of managing a program having a defined boundary and an associated tolerance for each of a plurality of program criteria, the method comprising the steps of: providing access to the program criteria and their associated boundaries and tolerances to a user; compiling, at a central computer, a current status for each of said plurality of program criteria based on inputted data; and displaying, on a display means associated with the central computer, the current status for one or more program criteria associated with said program, as well as the status of the boundary of the or each program criterion while having regard to the tolerance associated therewith.

According to yet another aspect of the invention, there is provided a system for managing a program, the program having a defined boundary and an associated tolerance for each of a plurality of program criteria, said system comprising: computer-readable memory means for receiving and storing inputted program information; first input means for inputting into said memory means a current status of a program criterion with respect to its boundary and the tolerance associated therewith; a central computer for compiling the current status for each of said plurality of program criteria; and a display means associated with the central computer for displaying the current status of the boundary of one or more program criteria, while having regard to the tolerance associated therewith.

According to a further aspect of the invention, there is provided a system for determining the status of one or more programs, each program having a defined boundary and an associated tolerance for each of a plurality of program criteria, said system comprising: computer-readable memory means for receiving and storing inputted program information; a central computer for compiling a current status for each of said plurality of program criteria, said current status having been inputted into said memory means and having been determined, for each program criterion, with respect to its boundary and the tolerance associated therewith; and a display means associated with the central computer for displaying the current status of the boundary of one or more program criteria, while having regard to the tolerance associated therewith.

Thus, in accordance with the present invention, a manager has the ability to effectively manage inter-related programs and their associated boundaries. Since a boundary in one program may be related to other programs or boundaries outside of the first program, the present invention permits a manager to observe these inter-relationships and determine how the status of a related program or boundary might affect the manager's program. Alternatively, an employee who is currently within all assigned boundaries could access the program manager system and offer help to someone who is having trouble staying within other boundaries.

### BRIEF DESCRIPTION OF THE DRAWINGS

Embodiments of the present invention will be further described with reference to the accompanying drawings, in which:

FIG. 1 illustrates a product-based hierarchical view of a plurality of programs according to an embodiment of the present invention;

FIG. 2 illustrates a detailed status view of a particular program from FIG. 1;

FIG. 3 illustrates a detailed content view of the same program from FIG. 1;

FIG. 4 illustrates a detailed quality view of the same program from FIG. 1;

FIG. 5 illustrates a detailed schedule view of the same program from FIG. 1;

FIG. 6 illustrates a detailed cost view of the same program from FIG. 1;

FIG. 7 illustrates a second product-based hierarchical view of a plurality of programs according to another embodiment of the present invention.

FIG. 8 illustrates a function-based hierarchical view of a plurality of programs according to a further embodiment of the present invention;

FIG. 9 illustrates a detailed functional view of a plurality of programs within the same functional grouping according to another embodiment of the present invention; and

FIG. 10 illustrates another detailed functional view of a plurality of programs within a plurality of functional groupings according to another embodiment of the present invention;

### DETAILED DESCRIPTION OF THE INVENTION

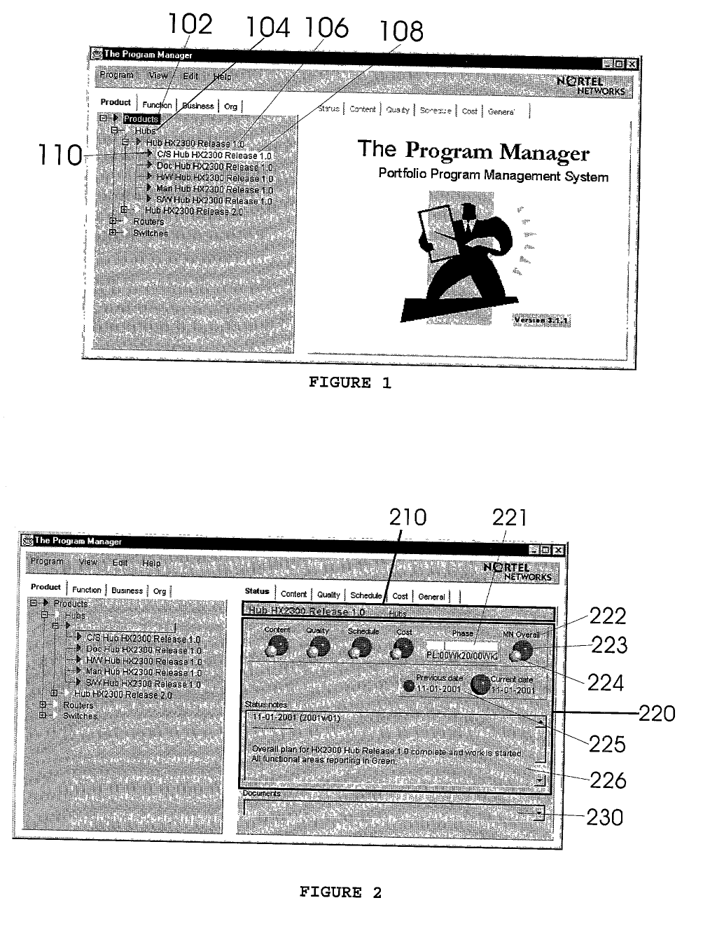

An example of a program manager according to the present invention is presented in FIG. 1, which is a screen shot illustrating a product-based hierarchical view of a plurality of programs according to an embodiment of the present invention. The left-hand side of the screen shot illustrates different top-level hierarchical views that may be employed. The embodiment shown in FIG. 1 illustrates the possibility of viewing programs according to: Product, Function, Business, and Organization. Although these views are well suited to the particular example described herein, it is to be understood that these views can be customized according to the nature of the particular program being managed. Top level 102 in FIG. 1 is the Products top level. Stemming from that top level 102 are product groupings 104. The product groupings 104 that are illustrated are: Hubs, Routers, and Switches. The particular “Hubs” product grouping 104 is further expanded into product programs 106 and product program components 108. In FIG. 1, it is possible to employ any one of hierarchical levels 102, 104, 106 or 108 in order to view the detailed information for a particular product, product grouping, product program, or product program component. The terms program component, program criterion, and sub-program will be used interchangeably herein.

For each hierarchical level, a status indicator 110 provides information on the current status of that level, as well as the trend with respect to the previous reporting of the status. In the embodiment shown in FIG. 1, a colored triangle is used as a status indicator. The color represents the status with respect to defined boundaries. In a preferred embodiment, the following colors may be used to indicate a given status: green: on target; yellow: off-target, but manageable; red: unmanageably off-target; white: undefined. Also in a preferred embodiment, the direction of the triangle represents the trend with respect to the last reporting date. The following directions may be used to indicate a given trend with respect to a status: pointing to the right: same status as previous date; pointing upwards: status improved since previous date; pointing downwards: status worsened since previous date. As such, a large amount of information is provided by means of the status indicator 110 without the need to view any of the detailed information relating to a program.

In FIG. 2, the product program “Hub HX2300 Release 1.0” has been selected in order to view the detailed status thereof at a given point in time. This status screen presents a wealth of information to the user of the program manager. In title area 210, information relating to the current and higher hierarchical levels is presented. In this case, since a product program is being viewed, the name of the product program 106 (Hub HX2300 Release 1.0) and the product grouping 104 (Hubs) are presented.

Program status area 220 includes information on the overall program as well as a boundary status for each of the boundaries. Program phase indicator 221 provides an indication as to the level of completion of the entire program, as well as a brief synopsis of the current milestone and its planned and forecasted dates of completion. The program status area 220 also comprises a plurality of boundary titles 222, current boundary status indicators 223 and previous boundary status indicators 224. In this case, it is seen that a large ball is used as the current status indicator 223, whereas a small ball is used as the previous status indicator 224.

The boundary date area 225 acts as a legend for the indicators 223 and 224, showing the actual dates of the previous status and current status, as well as illustrating which visual representation is used for each date.

Looking at the overall status illustrated in FIG. 2, its current boundary status 223 is indicated by a large “green” ball, meaning that it is on target. A small “white” ball indicates its previous boundary status, signifying that the boundary status was undefined as of the previous status date.

The final component of status area 220 is status notes area 226. The status notes area 226 provides an area wherein notes on the current status, which have been inputted by a particular user, can be viewed by any user.

A documents area 230 provides an area wherein uniform resource locators (URLs) relating to the particular program may be listed. Thus, any user of the system may be able to obtain additional information on the particular program with respect to its objectives, deadlines, etc.

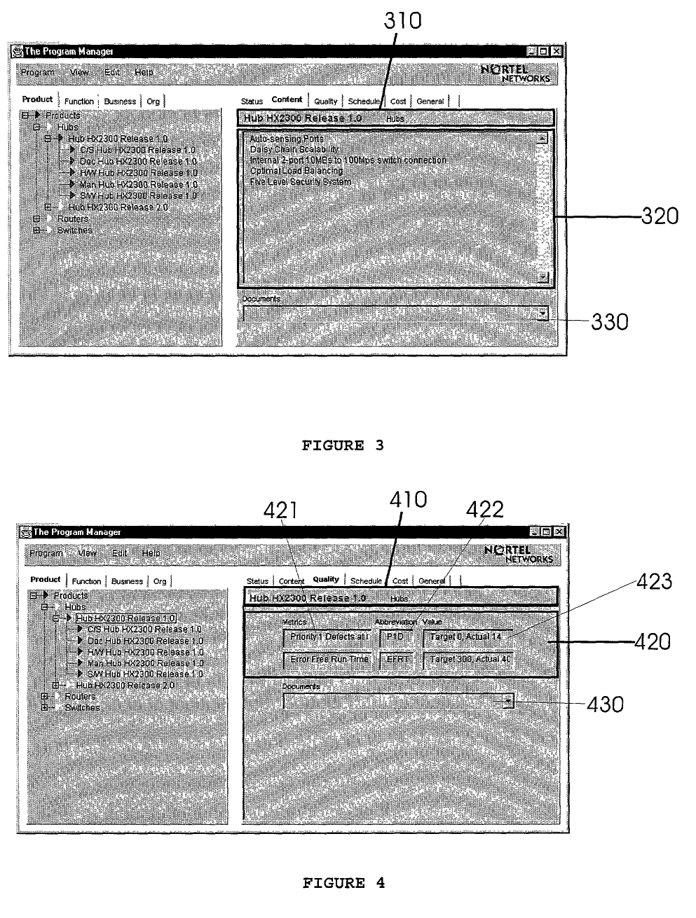

FIG. 3 illustrates a detailed content view of a particular program from FIG. 1. This detailed view provides a user with an indication of what is actually being done in the particular program. This view is similar to the detailed status view of FIG. 2 in that there is a corresponding title area 310 and a documents area 330. In FIG. 3, content area 320 contains information that has been inputted relating to the content of the program and the various tasks involved. This information permits a user to access basic information relating to the content of the program, with the ability to obtain further information by consulting one of the content documents listed in document area 330.

FIG. 4 illustrates a detailed quality view of a particular program from FIG. 1. This detailed view provides a user with an indication of the measures, metrics and schedules used to assess the quality of the particular program. This view is similar to the other detailed views in that there is a corresponding title area 410 and a documents area 430. In FIG. 4, quality area 420 contains information relating to the quality standards as well as the status with respect to those standards. Metrics 421 are listed along with an associated abbreviation 422. A corresponding value 423 is displayed, having both a target value and an actual value. A user may obtain further information on the quality metrics by consulting one of the quality documents listed in documents area 430.

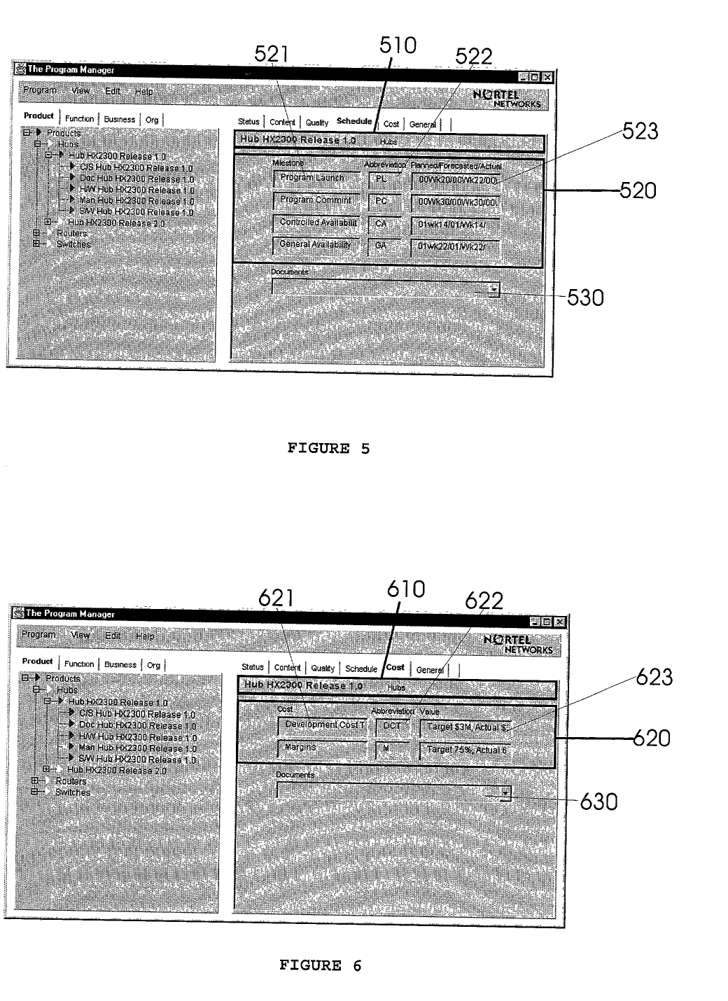

FIG. 5 illustrates a detailed schedule view of a particular program from FIG. 1. This detailed view provides a user with an indication of the schedules involved with various phases of the program. This view is similar to the other detailed views in that there is a corresponding title area 510 and a documents area 530. In FIG. 5, schedule area 520 contains information relating to program milestones 521. Along with an associated abbreviation 522, schedule data 523 is provided to indicate the planned, forecasted, and actual timelines associated with each milestone 521. A user may obtain further information by consulting one of the schedule documents listed in documents area 530.

FIG. 6 illustrates a detailed cost view of a particular program from FIG. 1. This detailed view provides a user with an indication of the costs related to various aspects of the program. This view is similar to the other detailed views in that there is a corresponding title area 610 and a documents area 630. In FIG. 6, cost area 620 contains a listing of costs 621, associated abbreviations 622, and cost value 623, including a target value and an actual value. A user may obtain further information by consulting one of the cost documents listed in documents area 630.

A preferred embodiment of the present invention has been described above with the Status, Content, Quality, Schedule, Cost, and General detailed views that are available from within any one of the hierarchical views.

These detailed views are well suited to this particular example. However, the present invention also permits the user to customize these detailed views according to the nature of the particular program being managed.

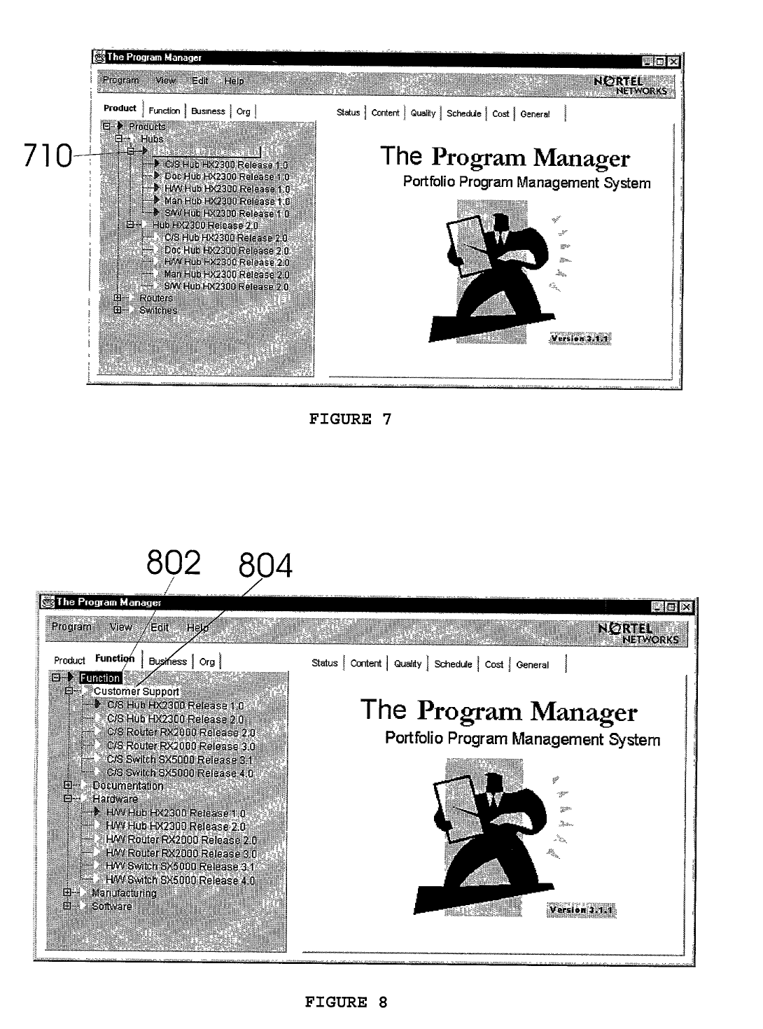

FIG. 7 illustrates a second product-based hierarchical view of a plurality of programs according to an embodiment of the present invention. This figure illustrates the fact that it is possible to view the status of a plurality of programs (and their components) at the same time. In this case, it is possible to concurrently observe two releases of similar programs with respect to all of the program components involved. Obviously, the status of the individual components of Release 1.0 will have a direct effect on the status of the individual components of Release 2.0. Again, status indicator 710 provides an indication of the current status as well as the trend for that status for any hierarchical level of a program. Although this example provides a straightforward example of inter-related program components from different programs, it is evident that two programs that are unrelated in name could have some common boundaries that will affect each other, particularly with respect to schedule and cost. This permits the management of multiple programs across various layers and functions. The present invention is also scalable such that programs of varying degrees of complexity may be compared in order to determine the effect that one component from one program may have on another component from another program.

FIG. 8 illustrates a function-based hierarchical view of a plurality of programs according to an embodiment of the present invention. In this case, the hierarchy of the programs being viewed is not based on a specific product, but on a particular function. Top level 802 is then extended to its constituent functional groupings 804. Thus, programs related to customer support, documentation, hardware, manufacturing and software are all grouped accordingly. It can be seen from FIG. 7 that the tasks related to Hub HX2300 Release 1.0 are on target, while the remaining task statuses are, as of yet, undefined.

It is thus apparent that a user may be able to switch from a Product view (as in FIGS. 1-7) to a Function view, while keeping track of the same program(s). As such, a user is better able to consider what factors may affect a particular program and what other issues may bear on the ability to complete a certain program component. Furthermore, all of this is accomplished in an integrated package.

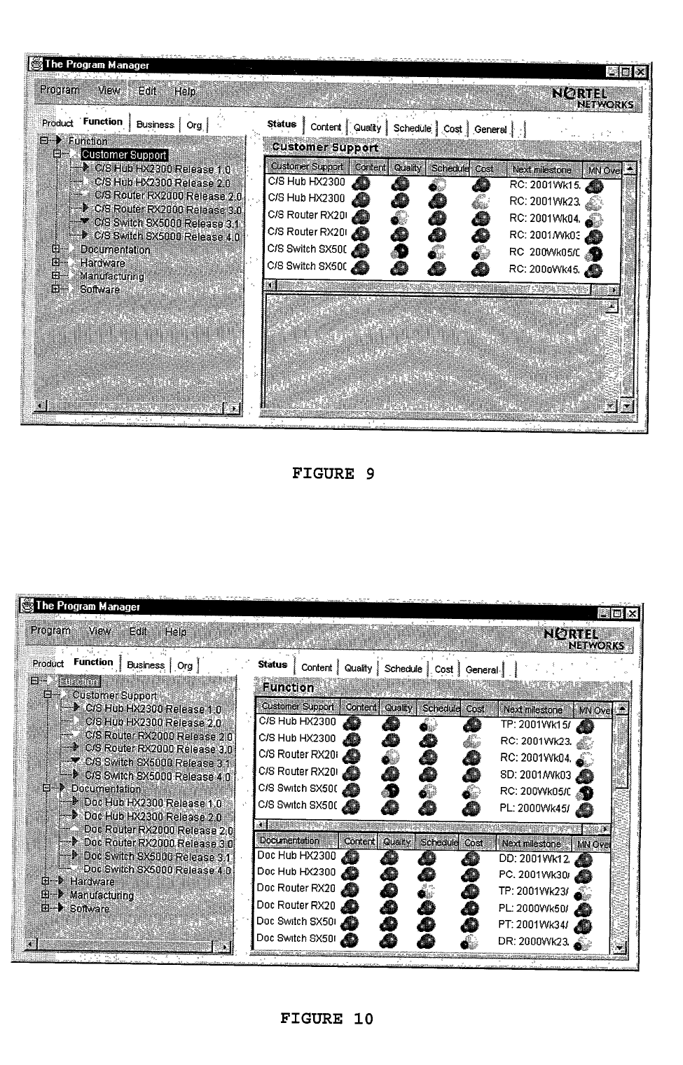

FIG. 9 illustrates a detailed functional view (called a level 1 view) of a plurality of programs within the same functional grouping. FIG. 9 provides a detailed version of the same type of information that was made available in FIG. 8. In particular, the status of each boundary, the associated phase and overall status of each program in the group selected on the left (Customer Service) is displayed on the right. Consequently, a user is able to view detailed status information relating to boundaries associated with many programs within a functional grouping.

FIG. 10 illustrates another detailed view (called a level 2 view) of a plurality of programs from a plurality of groupings. In particular, FIG. 10 illustrates a detailed view of the programs within both the Customer Service and Documentation groups. Again, the status of each boundary, the associated phase, and the overall status of each program are displayed for programs from each of the selected groupings. Consequently, a user is able to view detailed status information relating to boundaries associated with many programs from a plurality of functional groupings. As such, this view provides a great deal of information to a user in terms of being able to quickly assess the status of a plurality of inter-related cross-functional programs and their boundaries.

It can be understood that the programs listed in any of the above views can, themselves, comprise many other programs. As such, each program can, in fact, be a nested program, comprising a plurality of sub-programs of varying hierarchical level. The term sub-program refers only to the hierarchical relationship to the higher-level program, not to the significance or self-sufficiency of the sub-program. As such, any program criterion, program component, or sub-program may itself be a full program that it is simply concerned with boundaries that are all related to a lower functional level. Obviously, each such program criterion may itself be a nested program, continuing to any number of hierarchical levels. Therefore, embodiments of the present invention also may allow for the display of cross-functional views of various programs, showing the status of each boundary, the program/boundary phase, and overall status for each program as well as the sub-programs that may be comprised therein.

Although embodiments of the present invention have been presented with respect to Product and Function views, it will be apparent to one skilled in the art that many other views, such as those by Business and Organization are possible in order to obtain a better understanding of a particular program or the inter-related factors relating to a plurality of programs. Furthermore, the present invention permits a user to customize these view types in accordance with the characteristics of the program(s) being managed, or in accordance with any other user-selected criterion.

In addition to presenting program information as has been shown in the figures, the present invention may also export this information in a variety of formats. For instance, a web site can be automatically generated for a given program or group of programs. Electronic presentations, such as in Microsoft PowerPoint™ format, can also be automatically generated from the centralized program manager database when needed. In this way, a manager is relieved of the tasks of: compiling such information from a variety of disparate sources; and rendering such information in a presentable format. Moreover, since the data in the program manager database is always current, such presentations may quickly and easily be regenerated in updated format at any given point in the life of the program.

Furthermore, an embodiment of the present invention may also provide a functionality whereby a program manager is notified when a boundary violation has occurred. For instance, the boundary status may be displayed as on target, manageably off target, unmanageably off target, or undefined. Such an embodiment could include the functionality of notifying a program manager when a boundary violation has occurred by virtue of the associated tolerance having been exceeded. Alternatively, the notification could be made when a boundary violation classified as unmanageably off target has occurred, or any other triggering condition defined by a program manager. This notification could be by electronic mail, pager, short message service or by any other automated messaging or notification means known in the art.

What is claimed is:

1. A method of managing a program having a defined boundary and an associated tolerance for each of a plurality of program criteria, the method comprising the steps of:
providing access to the program criteria and their associated boundaries and tolerances to a user;
inputting, by said user, the current status of a particular program criterion with respect to its boundary and the tolerance associated therewith;
compiling, at a central computer, a current status for each of said plurality of program criteria; and
displaying, on a display means associated with the central computer, the current status for one or more program criteria associated with said program, as well as the status of the boundary of the or each program criterion while having regard to the tolerance associated therewith.

2. A method according to claim 1 wherein the boundary status may be displayed as on target, manageably off target, unmanageably off target, or undefined.

3. A method according to claim 1 further comprising the step of:
notifying a program manager when a boundary violation has occurred by virtue of the associated tolerance having been exceeded.

4. A method according to claim 2 further comprising the step of notifying a program manager when a boundary violation classified as unmanageably off target has occurred.

5. A method of managing a program having a defined boundary and an associated tolerance for each of a plurality of program criteria, the method comprising the steps of:
providing access to the program criteria and their associated boundaries and tolerances to a user;
compiling, at a central computer, a current status for each of said plurality of program criteria based on inputted data; and
displaying, on a display means associated with the central computer, the current status for one or more program criteria associated with said program, as well as the status of the boundary of the or each program criterion while having regard to the tolerance associated therewith.

6. A method according to claim 5 wherein the boundary status may be displayed as on target, manageably off target, unmanageably off target, or undefined.

7. A method according to claim 5 further comprising the step of:
notifying a program manager when a boundary violation has occurred by virtue of the associated tolerance having been exceeded.

8. A method according to claim 6 further comprising the step of notifying a program manager when a boundary violation classified as unmanageably off target has occurred.

9. A system for managing a program, the program having a defined boundary and an associated tolerance for each of a plurality of program criteria, said system comprising:
computer-readable memory means for receiving and storing inputted program information;
first input means for inputting into said memory means a current status of a program criterion with respect to its boundary and the tolerance associated therewith;
a central computer capable of communicating with said memory means for compiling the current status for each of said plurality of program criteria; and
a display means associated with the central computer for displaying the current status of the boundary of one or more program criteria, while having regard to the tolerance associated therewith.

10. A system according to claim 9 further comprising:
second input means for inputting into said memory means a boundary for a program criterion, and a tolerance with respect to said boundary.

11. A system for determining the status of one or more programs, each program having a defined boundary and an associated tolerance for each of a plurality of program criteria, said system comprising:
computer-readable memory means for receiving and storing inputted program information;
a central computer for compiling a current status for each of said plurality of program criteria, said current status having been inputted into said memory means and having been determined, for each program criterion, with respect to its boundary and the tolerance associated therewith; and
a display means associated with said central computer for displaying the current status of the boundary of one or more program criteria, having regard to the tolerance associated therewith.

12. A system according to claim 11 wherein said one or more programs are nested programs, each comprising other programs, the other programs appearing as program criteria with respect to said one or more programs on said display means.

13. A system according to claim 11 wherein said one or more programs belong to a plurality of functional groupings.

14. A system according to claim 11 wherein the program information in said central computer is made available to an external means for further manipulation.

15. A computer-readable memory encoded with executable instructions representing a computer program that causes a computer to perform the method of claim 1.

16. A computer-readable memory encoded with executable instructions representing a computer program that causes a computer to perform the method of claim 5.
